(19) United States
(12) Patent Application Publication
(10) Pub. No.: US 2018/0147745 A1
(43) Pub. Date: May 31, 2018

(54) BLADE HEAD, BLADE AND METHOD FOR ELIMINATING SPACERS IN MULTIPLE BLADE STACKS

(71) Applicant: Diamond Products, Limited, Elyria, OH (US)

(72) Inventor: Karl H. Moller, North Palm Beach, FL (US)

(21) Appl. No.: 15/800,950

(22) Filed: Nov. 1, 2017

Related U.S. Application Data
(60) Provisional application No. 62/426,859, filed on Nov. 28, 2016.

(51) Int. Cl. B28D 1/04; B28D 1/06

(52) U.S. Cl. CPC B28D 1/048; B28D 1/045; B28D 1/041; B28D 1/068

(57) ABSTRACT

A product and method to eliminate blade spacers in blade heads or stacks that are formed by multiple blades fixed relative to one another including a plurality of spacerless blades wherein the spacerless blades include a blade core with a blade core thickness that is greater than a segment thickness of grinding and/or cutting segments fixed to the blade core to allow core-to-core contact between adjacent blades in the plurality of spacerless circular blades while also producing segments spacings in the plurality of segments between the adjacent blades without the need for blade spacers.

This application claims priority to provisional patent application Ser. No. 62/426,859 filed on Nov. 28, 2016, which is incorporated by reference herein.

The invention of this application relates to grinding and cutting blades and has been found to work particularly well with blades that are stacked together to form a grinding or cutting blade head or stack. And, more particularly, the invention relates to a blade configuration and a method of eliminating blade spacers in a grinding and cutting heads when multiple blades are stacked together to form the grinding or cutting blade head.

### INCORPORATION BY REFERENCE

The invention of this application relates to grinding and cutting blades and has been found to work particularly well with blades that are stacked together to form a grinding or cutting blade head. U.S. Pat. No. 6,142,139 to Lupi discloses a system of modular elements for machining marble and is incorporated by reference herein for showing the same. U.S. Pat. No. 6,526,959 to Lee et al. discloses an adhesive sheet for noise and shock absorption and a saw blade making use of it and is incorporated by reference herein for showing the same. U.S. Pat. No. 3,127,887 to Metzger discloses a diamond saw blade assembly and is incorporated by reference herein for showing the same. Patent Publication No. US 2010/0126327A1 to Cabral discloses a concrete joint cutting and routing blade and is incorporated by reference herein for showing the same.

### BACKGROUND OF THE INVENTION

When grinding blades are used to grind or groove surfaces, such as concrete, several grinding blades are often stacked side by side to form a grinding head. These grinding heads can be formed from hundreds of grinding blades that require blade spacers between each adjacent blade. The blade spacers are needed to maintain metal-to-metal contact between the cores of the blades and to prevent the diamonds of the grinding segments of one blade from contacting the diamonds on the grinding segments of an adjacent blade. In addition, blade spacers can be used to create a desired spacing between the grinding segments of the blades in the grinding head. The same is true for cutting blades that are stacked together to form a multiple blade stack or blade head.

In prior art grinding and cutting heads, the spacing between the blades are formed by sheet steel ground to a desired thickness and wherein the blade spacers are manually positioned between each of the blade cores of the blades that form the blade stack. When working with large grinding heads, the heads can have hundreds of grinding blades wherein hundreds of blade spacers must be manually positioned between each of the grinding blades. The blade spacers add both component costs to the grinding and cutting head and labor costs associated with the manual placement of the blade spacers between the blades. As can be appreciated, manually positioning hundreds of blade spacers between each blade is time consuming. Moreover, many blade spacers cannot be reused.

### SUMMARY OF THE INVENTION

The invention of this application relates to a product and method of eliminating blade spacers in blade stacks that includes a plurality of blades and, more particularly, to a grinding and/or cutting blade, blade stack or blade head that does not require blade spacers between blades to allow core-to-core contact between adjacent blades and to produce a desired grinding segment spacing in a blade stack having multiple blades that forms the grinding or cutting blade head.

The product and method of this application relates to blades and blade heads or stacks that are formed by multiple blades fixed relative to one another wherein at least one blade within the blade stack has a blade core with a blade core thickness that is greater than a segment thickness of a grinding and/or cutting segment to eliminate the need for one or more blade spacer between adjacent blades wherein the segment thickness includes the dimensional changes produced by diamonds.

As will be referenced more below, the invention of this application primarily relates to grinding heads, but the invention can be used in connection with grinding and/or cutting heads, stacks and/or blades. Accordingly, while the description below references primarily grinding heads, blades and/or segments, the invention of this application and the description of this specification covers both grinding and other types of cutting heads and/or blades.

According to one aspect of the invention of this application, the core thickness of one or more blades in a blade stack is greater than the grinding segment thickness to both allow core-to-core contact between adjacent blades and produce a desired segment spacing between adjacent segments without the need of blade spacers between adjacent blades.

According to another aspect of the invention of this application, the core thickness of the blade produces a circumferential surface or edge of the blade core that has a circumferential edge width that allows more than one axially spaced grinding segments to be fixed relative to the circumferential edge.

According to yet another aspect of the invention of this application, the grinding segment has a segment thickness center and the blade core has a core thickness center wherein the blade stack can include one or more blades wherein the segment thickness center is aligned with the core thickness center thereby centering the grinding segment axially with the blade core.

According to other aspects of the invention of this application, the blade stack can include one or more blades wherein the segment thickness center is offset from the core thickness center thereby offsetting the grinding segment from the blade core to both produce a desired segment spacing between adjacent segments and/or create at least one side clearance for the overall blade stack including creating segment overhands along with segment insets.

By creating a segment spacing between grinding segments with an enlarged core thickness, blade spacers can be eliminated between each of the blades in the blade stack. Yet further, by including at least one end blade with a modified grinding segment arrangement, desired side clearance and/or clearances can be produced also without the need for blade spacers.

According to yet other aspects of the invention of this application, the elimination of the spacers between the blades in the blade stack also allows the adjacent blades to be welded together to further improve stiffness. According to certain aspects, this can include one or more weld holes or openings in the blade core that allow for weld points to weld adjacent blades together.

Yet even further, it has been found that the elimination of the blade spacers according to the invention of this application has many advantages over the prior art. One such advantage is a significant reduction in assembly time and cost. As an example, a grinding head with blades according to certain aspects of the invention of this application reduced overall costs of one of Applicant's blade stack by over five thousand dollars. This included a reduction in assembly time of over ten hours. Yet even further, the invention of this application reduces vibration wherein it results in a more stable blade stack, which improves the performance of the blade head and extends the life of the blade head. Even yet further, the invention of this application prevent debris from getting between the blades in the blade head, which further reduces vibration and extends blade head life. Yet another advantage found with the blades according to the invention of this application is that they allow the blades to be welded together, which further improves the overall stiffness or structure of the blade head or stack and further reduces vibration thereby further improving performance and blade life. Accordingly, the invention of this application has been found to reduce costs while at the same time improve performance and improve longevity.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 is a partial sectional view of a blade stack or blade head from the prior art;

FIG. 2 is an enlarged view of the prior art taken from FIG. 1;

FIG. 3 is a side view of a blade stack according to certain aspects of the invention of this application;

FIG. 4 is an end perspective view of the blade stack shown in FIG. 3;

FIG. 5 is an end view of a blade form the blade stack shown in FIGS. 3 & 4 that shows certain aspects of the invention of this application;

FIG. 6 is a partial sectional view of a blade stack or blade head taken along lines 6-6 in FIG. 5 showing certain aspects of the present invention;

FIG. 7 is an enlarged view of the sectional view from FIG. 6;

FIG. 8 is a partial sectional view similar to FIG. 6 showing certain other aspects of the present invention;

FIG. 9 is an enlarged view of the sectional view from FIG. 8.

FIG. 10 is a partial sectional view similar to FIG. 6 showing yet other aspects of the present invention;

FIG. 11 is an enlarged view of the sectional view from FIG. 10;

FIG. 12 is an enlarged partial sectional view similar to FIG. 7 showing even yet other aspects of the present invention; and,

FIG. 13 is an enlarged sectional view showing yet other embodiments of the invention of this application; and,

FIG. 14 is an enlarged sectional view showing even yet another embodiment of the invention of this application

### DESCRIPTION OF PREFERRED EMBODIMENTS

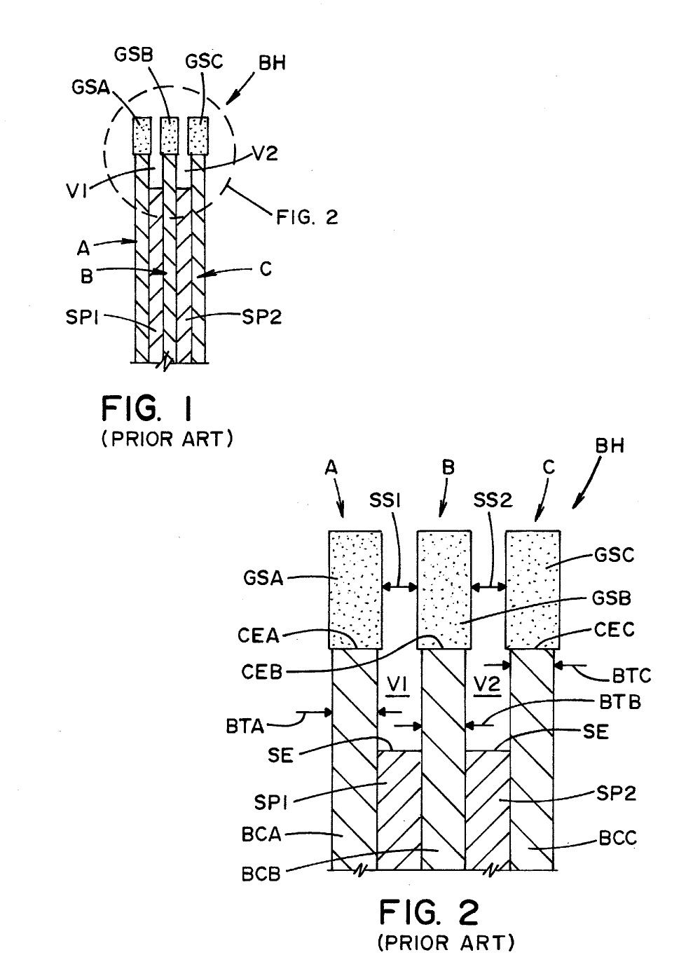

Referring now to the drawings wherein the showings are for the purpose of illustrating preferred and alternative embodiments of the invention only and not for the purpose of limiting the same, FIGS. 1 and 2 show a partial section of a prior art blade stack or blade head BH that includes blades A, B and C. While only three blades are shown, a blade stack can include many blades wherein some blade stacks include hundreds of blades. Further, several of the figures of this application show only one side of the blade stack wherein these blades are circular blades and there is a similar circumferentially extending edges (not shown in all figures) on the opposite side of a central head axis of the blade head shown. In addition, the drawings of this application are not to scale and are not intended to be exactly proportional wherein certain features have been enlarged to better show and/or describe the invention of this application.

The blades in the blade stack include a blade core BC and a plurality of grinding or cutting segments GS. As noted above, the invention of this application primarily relates to grinding heads, but the invention can be used in connection with grinding and/or cutting heads, stacks and/or blades. Accordingly, while the description primarily references grinding heads, blades and/or segments, the invention of this application covers both grinding and other types of cutting heads and/or blades. Grinding segments GS are secured relative to the blade core about a circumferential edge CE of the blade core to produce the grinding and/or cutting blade. In that grinding and cutting blades are known in the art, they will not be discussed in greater detail herein in the interest of brevity. Again, the blades of this application are circular blades that have a circular circumferential edge extending about a central head axis (not shown in these two figures). Accordingly, depending on the size or diameter of the blade, the blade has a plurality of grinding or cutting segments circumferentially spaced about this circumferential edge of the blade core. For larger diameter blades, this can include dozens of grinding segments GS circumferentially spaced about edge CE. In addition, the blades can come in a wide range of diameters wherein the invention of this application is not to be limited to any particular size or type of grinding and/or cutting blade. Yet further, the grinding segments can be any type of grinding segment known in the art now or in the future.

In order to produce a desired segment spacing SS between adjacent grinding or cutting segments GS, grinding head BH includes blade spacers. In the example shown, there are two blade spacers SP1 and SP2, but this is an example only wherein the blade stack can include many blades and many blade spacers. The Examples are intended to generally show a central region of the blade stack and the ends of a blade stack. The spacers in prior art blade stacks can be circular in configuration and can have an outer circumferential edge SE. In the example shown, blade head BH includes a first spacer SP1 that is positioned between blades A and B and a second spacer SP2 that is positioned between blades B and C. By including spacers SP1 and SP2, adjacent grinding segments can be spaced from one another to prevent diamond-to-diamond contact between the segments. Instead, there is metal-to-metal contact between blade cores BC and spacers SP. Further, a desired segment spacing can also be created for grooving concrete. In order to assemble grinding head BH, a spacer must be manually positioned between each blade core to produce the needed spacing between the cutting segments of the blade head.

In that prior art grinding segments GS can be made from sheet stock, such as metal and/or aluminum sheet stock, that has generally the same material thickness as the blade core, the finished segments have a segment thickness that is greater than the core thickness of the blade in view of the diamond coating on the segments. Further, the methods used to attach the segments to the blade core can also increase the overall thickness of the segments. Therefore, even if spacing between adjacent segments is not desired, spacers are still required to maintain metal-to-metal contact between the blade cores and spacers to produce at least a minimal gap between adjacent grinding segments to prevent diamond-to-diamond contact. In this situation, where spacers are only needed to prevent diamond-to-diamond contact, spacers SP can be very thin, such as spacers having a thickness of only about 0.030″. As can be appreciated, it can be very difficult to work with such thin sheet stock. In that the spacers are purchased in bulk, it can be difficult to even separate the spacers from one another before assembly if they have a thickness of 0.030″. Further, it is difficult and time consuming to position hundreds of spacers between the grinding blades. Yet even further, the spacers can be less than optimal for the overall performance of the grinding head, which is discussed more below.

Moreover, as is shown, spacers SP do not have the same diameter as the blade cores wherein spacer SP have an outer circumferential edge SE that is radially spaced from core edge CE wherein prior art spacers SP can produce a void V between adjacent blade cores BC. This radial spacing both reduces the metal-to-metal contact within the blade head and produces voids V1 and V2 between the blade cores. These voids can trap dirt and debris that can have an adverse effect on balance and grinding/cutting. Moreover, the void spaces the metal-to-metal contact between blades away from the grinding/cutting segments wherein the void can create segment vibration that can both reduce grinding performance and blade longevity.

Therefore, there is a need in the industry to eliminate these spacers to both reduce costs, reduce labor, improve the overall performance and improve longevity of the blade head.

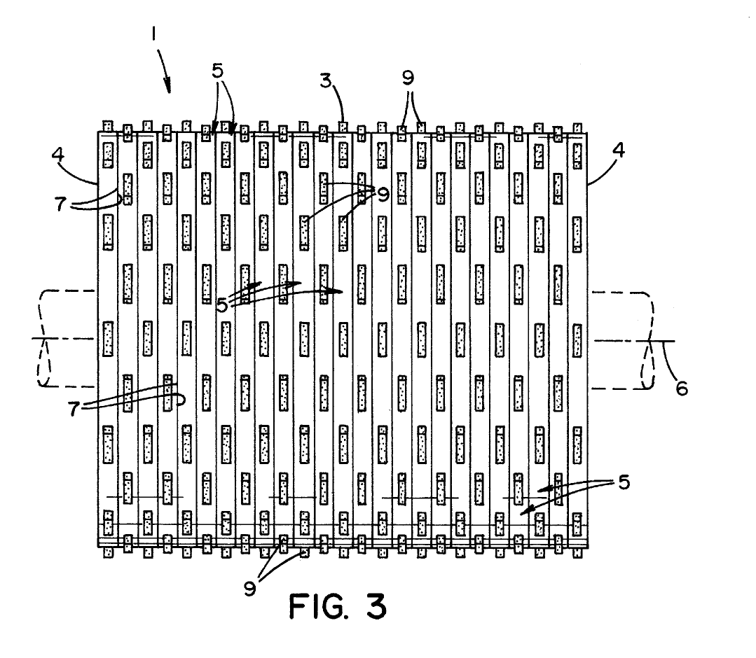

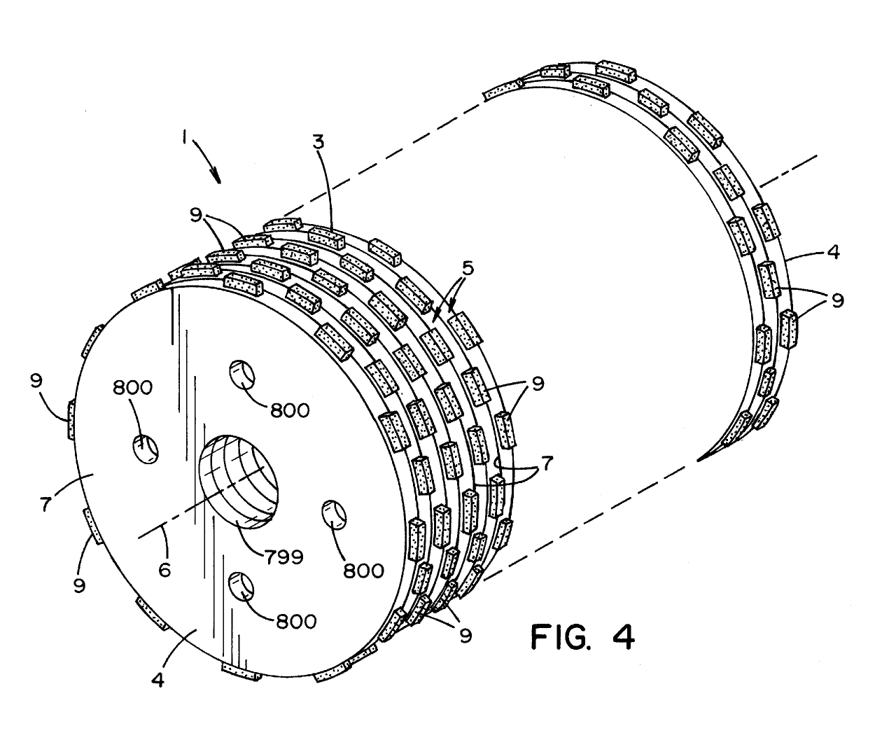

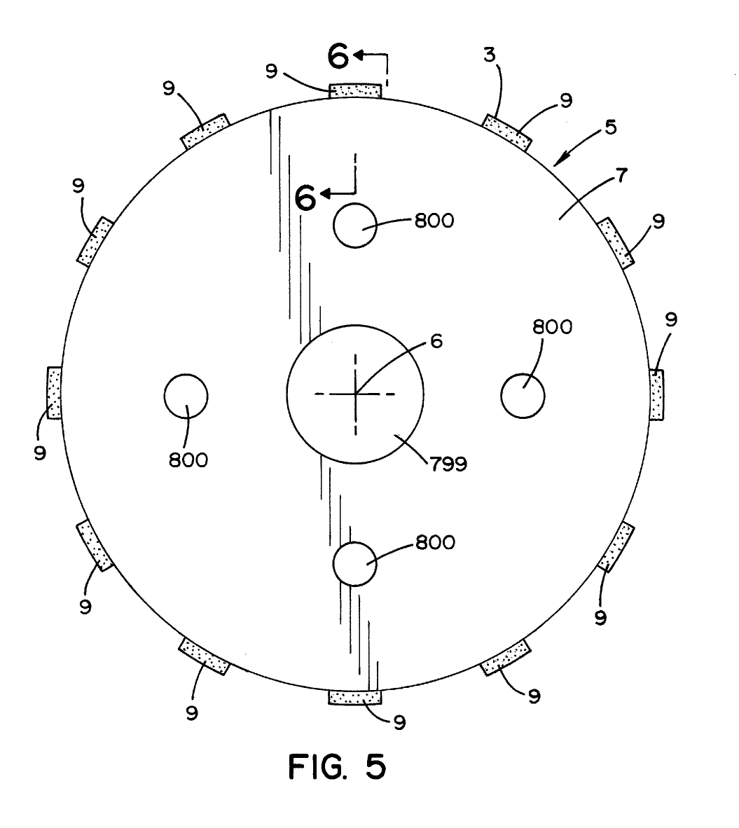

Referring now to FIGS. 3-5, FIGS. 3 and 4 shown is a general overall representation of a blade head 1, which will be discussed more below. Blade head 1 is formed by a stack of blades and has a circumferential grinding or cutting surface or edge 3. The blade head extends between blade stack sides or extents 4. Blade stack or head 1 is formed by blades 5 that rotate about a blade axis 6 and that are stacked directly against one another wherein side faces 7 of the blades engage a side face 7 of an adjacent blade. FIG. 5 shows an enlarged view of the side of the blade stack that also shows a side view of one of blades 5. Each blade 5 includes a plurality of grinding or cutting segments 9 that at least in part form edge 3. The remaining figures of this application are for the purpose of illustrating preferred and alternative embodiments of the invention only and not for the purpose of limiting the same and are provided with reference to FIGS. 3-5.

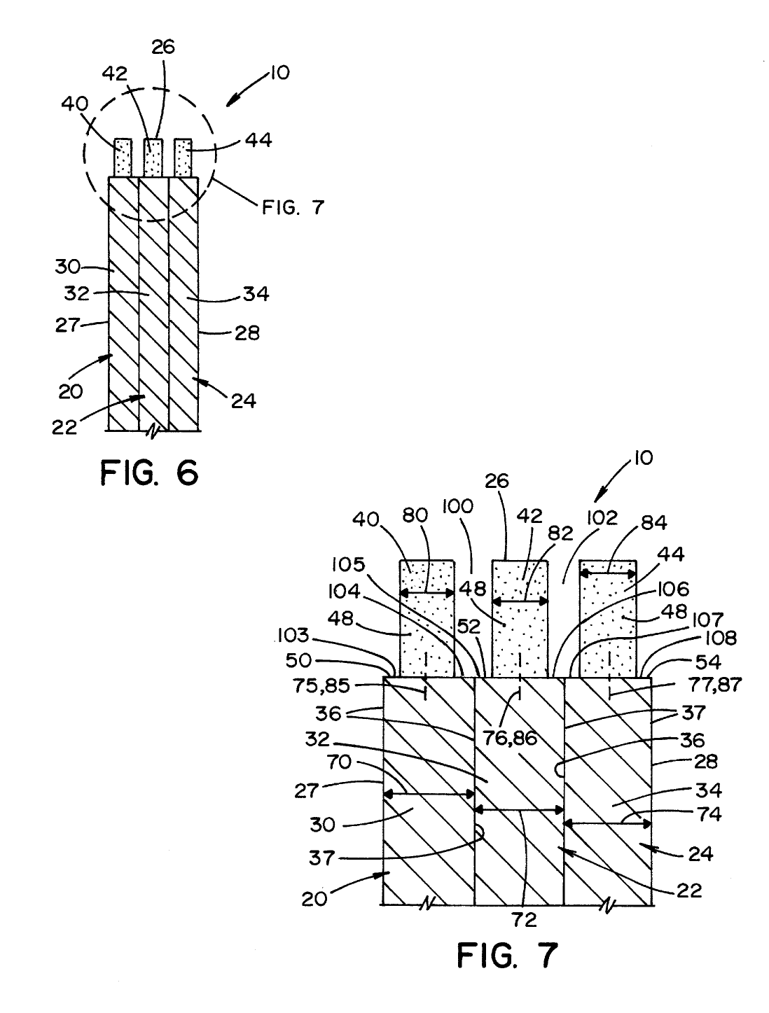

With reference to FIGS. 6 and 7, shown is a blade head 10. As with all embodiments of this application, blade head 10 can be either a cutting head and/or a grinding head. Moreover, these figures show only three circular blades 20, 22 and 24 of blade head 10, for illustrative purposes only, wherein the blade head or stack can include any number of blades without detracting from the invention of this application. Three blades are used in this description in the interest of brevity only in that three blades sufficiently show the inventive concept of this application including a representation of a central section and end sections. However, the blade shown in all embodiments could be any section within the blade stack. Again, the remaining figures of this application are provided in combination with FIGS. 3-5 to illustrate that the blade heads can include many blades. Moreover, these figures can represent end portions and/or central portions of the blade stack. In addition, FIGS. 6 and 7 show only half of the blades wherein there is an opposite edge portion (not shown in these figures) that can be an equal and opposite edge portions, which again is not shown in the interest of brevity.

In greater detail, blade head 10 includes a plurality of blades 20, 22 and 24 that form blade head 10 that includes a circumferential grind or cutting surface or edge 26. In this embodiment, blades 20, 22 and 24 are all spacerless. Blade head 10 rotates about a blade axis and are stacked directly against one another wherein there is core-to-core contact between adjacent blades in that the side faces of the blades engage a side face of an adjacent blade. Blade stack 10 further includes opposite blade stack sides or extents 27 and 28.

Blades 20, 22 and 24 include blade cores 30, 32 and 34, respectively. Each blade core includes opposite blade core side faces 36 and 37. In the embodiment shown, surface 36 of core 30 can form blade stack side 27 and surface 37 of blade core 34 can form blade stack side 28. In addition, side face 37 of core 30 directly engages side face 36 of core 32, and side face 37 of core 32 directly engages side face 36 of core 34 wherein the blade cores directly engage one another.

Blades 20, 22 and 24 further include grinding and/or cutting segments 40, 42 and 44, respectively. Segments 40, 42 and 44 can include diamonds 48. The segments in the embodiments of this application can be any segment known in the art wherein they can comprise almost any metal including a mixture of metals such as, for example, one or more of molybdenum, silver, iron, copper, cobalt, and alloys of such metals, and metal carbides, and mixtures thereof, along with the diamonds. The segments can further include diamond particles/grit/powder 48 dispersed therein at a percentage, by weight, of the segments. The concentration and arrangement of diamond particles can be any that are known in the art, today or in the future, without detracting from the invention of this application. Further, the percentage can be varied between different portions of the cutting or grinding segments. Other compositions may be utilized as well. As is shown best in FIG. 5, the segments for each blade are a plurality of grinding and/or cutting segments fixed relative to and radially extending from the blade cores. As is shown in this set of embodiments, segments 40, 42 and 44 are fixed relative to circumferential edges 50, 52 and 54 of blade cores 30, 32 and 34, respectively. Again, only one segment is being shown for each blade to illustrate the invention of this application and not to limit the same. Moreover, this set of embodiments includes similar grinding segments on each core, which is not required and which will be discussed more below. Even yet further, this embodiment and others include cores have side core surfaces that extend uniformly to the circumferential edge wherein this is not required either.

In greater detail, blade cores 30, 32 and 34 have blade core thicknesses 70, 72 and 74 for the engagement surfaces of the cores, respectively, and core thickness centers 75, 76 and 77. Similarly, segments 40, 42 and 44 have segment thicknesses 80, 82 and 84, respectively wherein the thickness includes the dimensional changes produced by diamonds 48. The segments including segment thickness centers 85, 86 and 87. Segment thicknesses 80, 82 and 84 are less than blade core thicknesses 70, 72 and 74, respectively to produce segments spacings 100 and 102 between the segments without the need for spacers. In the embodiment shown, spacing 100 is between segments 40 and 42 and spacing 102 is between segments 42 and 44. In that spacers are not needed, hundreds of component parts can be eliminated from the blade head. Yet further, any desired spacing can be achieved between adjacent segments merely based on the different material thicknesses of the blade cores and/or segments and/or the placement of the segment centers. In the embodiment shown in FIGS. 6 and 7, segments 40, 42 and 44 are centered on blade cores 30, 32 and 34, respectively, wherein centers 75 and 85 are in general alignment, centers 76 and 86 are in general alignment and centers 77 and 87 are in general alignment. As will be discussed more below, this can be altered to create desired spacings and/or alignments and to produce negative clearance on the blade head sides. The smaller thickness of the segments produces segment insets that produce the segment spacings. In this respect, blade 30 includes segment insets 103 and 104 on either side of segment 40 that are generally equal. Similarly, blade 32 includes segment insets 105 and 106 that are on either side of segment 42 and are generally equal. Blade 34 includes segment insets 107 and 108 on either side of segment 42 that are generally equal. In this set of embodiments, segment spacing 100 is formed by insets 104 and 105 and segment spacing 102 is formed by insets 106 and 107.

By eliminating hundreds of components, component costs and inventory costs can be reduced. Moreover, labor costs to assemble, repair and/or modify blade head 10 can be greatly reduced in that spacers do not need to be positioned between each blade. Yet even further, it has been found that the invention of this application can improve the overall balance of the grinding and/or cutting blade head, reduce overall vibration, reduce vibration at the grinding and/or cutting segments, increase stiffness in the blade head, increase performance of the blade head and increase the life expectancy of the blade head. This is in part due to the increased metal-to-metal contact between adjacent blade cores wherein virtually the entire blade core can be configured to engage the adjacent blade core and this metal-to-metal, core-to-core contact is closer to the grinding/cutting segments. This increases the overall stiffness of the blade head and can reduce vibration. Moreover, having blade cores with an increased metal-to-metal, core-to-core contact eliminates the voids between blades (V1 and V2 in the prior art) that also prevents debris from collecting between the blades. Preventing debris collection between blades can provide at least some of the reduced vibration of the blade head according to the invention of this application. Yet further, the blade cores have increased thicknesses, which also improve overall rigidity and stiffness of the blade head. Increased rigidity and stiffness provide both a better grind and/or cut and improves blade head longevity. Thus, the invention of this application both reduces costs and the increases the performance and the longevity of the blade head.

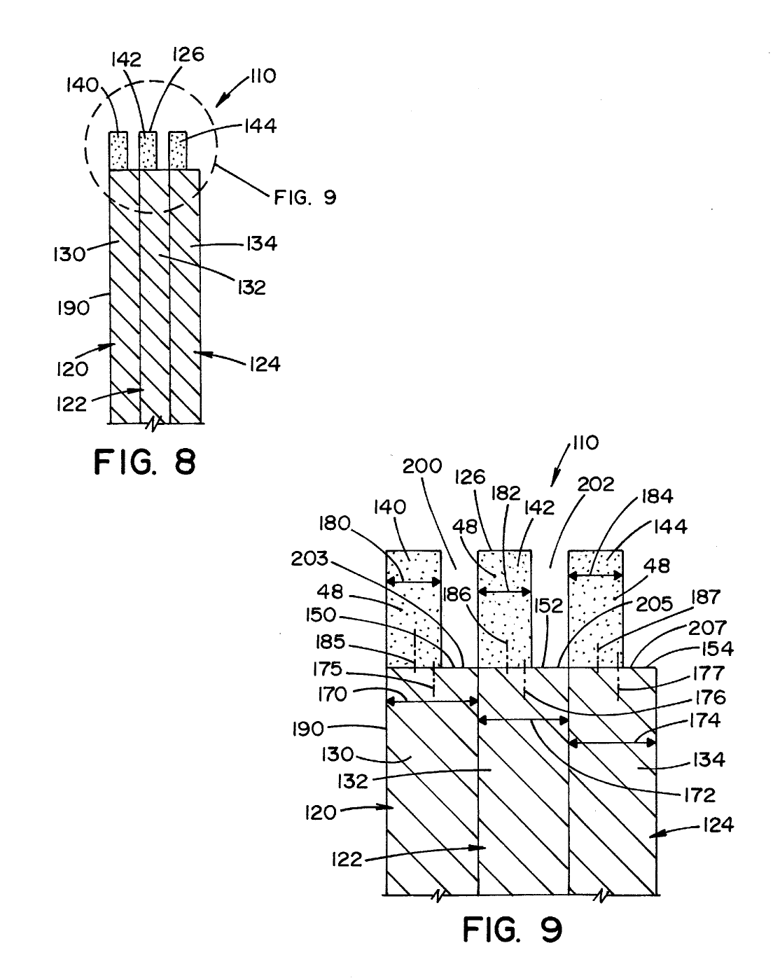

With special reference to FIGS. 8 and 9, shown is another set of embodiments. In this set of embodiments, there are again only three blades shown, which is illustrative only and is not to be limiting. Shown is a blade head 110 and three spacerless grinding and/or cutting blades 120, 122 and 124 of the blade head that form a circumferential grind or cutting surface or edge 126. Blades 120, 122 and 124 include blade cores 130, 132 and 134, respectively. Further, blades 120, 122 and 124 include grinding and/or cutting segments 140, 142 and 144, respectively. Segments 140, 142 and 144 can include diamonds 48 as discussed above. Again, while not shown in these figures, the segments for each blade are a plurality of segments fixed relative to and extending radially from core circumferential edges 150, 152 and 154 of blade cores 130, 132 and 134, respectively as is best shown in FIG. 5. Further, only one segment is being shown for each blade to illustrate the invention of this application and not to limit the same.

In this embodiment, blade cores 130, 132 and 134 have blade core thicknesses 170, 172 and 174, respectively, and core thickness centers 175, 176 and 177. Similarly, segments 140, 142 and 144 have segment thicknesses 180, 182 and 184, respectively, and segment thickness centers 185, 186 and 187. Segment thicknesses 180, 182 and 184 are less than blade core thicknesses 170, 172 and 174, respectively to produce segments spacings 200 and 202 between the segments without the need for spacers. However, in this set of embodiments, the segments are not centered wherein the segment thickness centers are misaligned from the core thickness centers, respectfully. In this respect, the segments are moved axially toward side 190 of blade head 110 of the corresponding blade core. As is shown, this is a left side shift with reference to the drawings. However, this shift could be to either side and not all blades need to have the same shift, which will be discussed more below. In that the segments are shifted to one side of the core, there can be a larger inset on a single side of the blade core circumferential edge. As is shown in this set of embodiments, blade 120 has an inset 203 on the right side of circumferential edge 150, blade 122 has an inset 205 on the right side of circumferential edge 152 and blade 122 has an inset 207 on the right side of circumferential edge 154. Thus, spacing 200 is between segments 140 and 142 and is formed from only the shift in segment 140 and inset 203. Similarly, spacing 202 is between segments 142 and 144 and is formed from only the shift in segment 142 and inset 205. Accordingly, while in this set of embodiments the segments are offset to one side of the blade cores to create the segment spacings, they can produce the same spacings as the embodiments shown in FIGS. 6 and 7. Moreover, the same overall segment spacing improvements can be achieved wherein the same cost savings and performance improvements can be achieved.

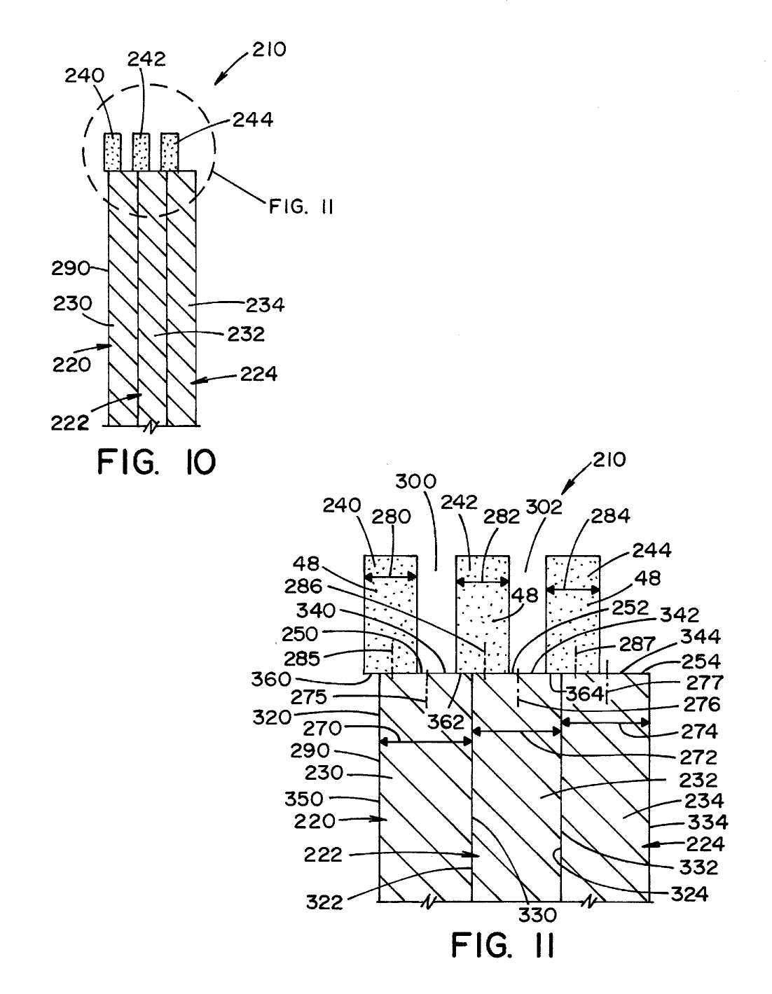

With special reference to FIGS. 10 and 11, yet another set of embodiments is shown. In this set of embodiments, there are again only three blades shown, which is illustrative only and is not to be limiting. Shown is a blade head 210 and three blades 220, 222 and 224 of blade head 210. Again, only the end portions of one side are shown for illustration purposes only. Blades 220, 222 and 224 include blade cores 230, 232 and 234, respectively. Further, blades 220, 222 and 224 include grinding and/or cutting segments 240, 242 and 244, respectively. Segments 240, 242 and 244 can include diamonds 48 as are described in greater detail above. Again, as is best shown in FIG. 5, the segments for each blade are a plurality of segments fixed relative to and extending radially from core circumferential edges 250, 252 and 254 of blade cores 230, 232 and 234, respectively. Again, only one grinding and/or cutting segment is being shown for each blade to illustrate the invention of this application and not to limit the same.

In this embodiment, blade cores 230, 232 and 234 have blade core thicknesses 270, 272 and 274, respectively, and core thickness centers 275, 276 and 277. Similarly, segments 240, 242 and 244 have segment thicknesses 280, 282 and 284, respectively, and segment thickness centers 285, 286 and 287. As with the embodiments above, segment thicknesses 280, 282 and 284 are less than blade core thicknesses 270, 272 and 274, respectively, to form spacerless blades that both allow core-to-core contact between adjacent blades and produce segments spacings 300 and 302 between the segments without the need for spacers. However, in this set of embodiments, the segments are not centered wherein the segment thickness centers are misaligned from the core thickness centers, respectfully. In this respect, the segments are moved axially toward side 290 of blade head 210 of the corresponding blade core. Spacing 300 is between segments 240 and 242, and spacing 302 is between segments 242 and 244. As with the embodiments shown in FIGS. 8 and 9 discussed above, the segments are offset to one side of the blade cores and this could be done on either or both sides. For example, a blade on the right side of blade head 210 could have grinding and/or segments shifted similarly to the right side, as will be discussed more below.

However, in this embodiment, the segments are shifted beyond a side edge of the blade cores to produce a side clearance. In this respect, blade cores 230, 232 and 234 have left side core edges (again, in reference to the figures in the drawings) 320, 322 and 324, respectively and right side core edges 330, 332 and 334. Blade 220 has a core inset 340 on the right side of circumferential edge 250, blade 222 has a core inset 342 on the right side of circumferential edge 252 and blade 224 has a core inset 344 on the right side of circumferential edge 254. However, in that the segments are shifted over the left side edges of the cores, there are also segment overhangs that can be used to create a side clearance on an outside edge 350 of blade head 210. In greater detail, blade 220 has an overhang 360 on left side 290 and on the base of segment 240, blade 222 has an overhang 362 on the left side of the base of segment 242 and blade 222 has an overhang 364 on the left side of the base of segment 244. In that segment 244 hangs over left edge 324 of core 234, the base of segment 244 hangs over onto circumferential edge 252 of core 232. Similarly, segment 242 hangs over left edge 322 of core 232 such that the base of segment 242 hangs over onto circumferential edge 250 of core 230. As can be appreciated, the base of the segments can be in direct engagement with the adjacent circumferential edge, but this is not required. Thus, spacing 300 between segments 240 and 242 and is a function of core inset 340 minus segment overhang 362. Similarly, spacing 302 between segments 242 and 244 and is a function of core inset 342 minus segment overhang 364. This can produce the same overall segment spacing as discussed above with the same cost savings and performance improvements. Further, the segment alignment of this set of embodiments can further produce side overhang 360 on outside edge 350 for a side 290 of a blade head.

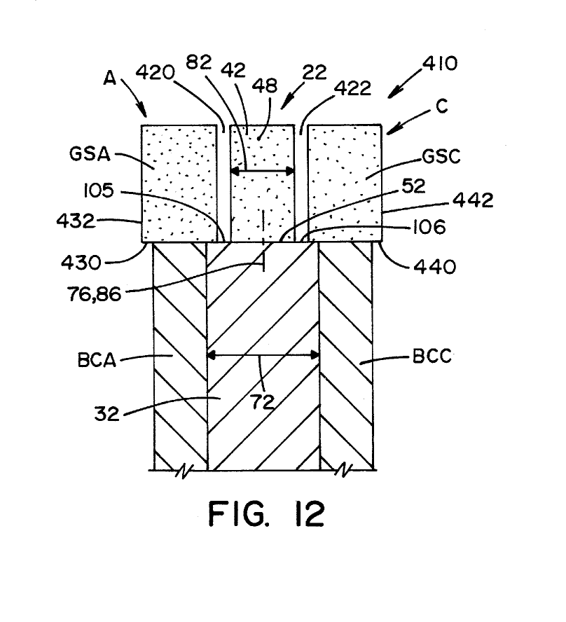

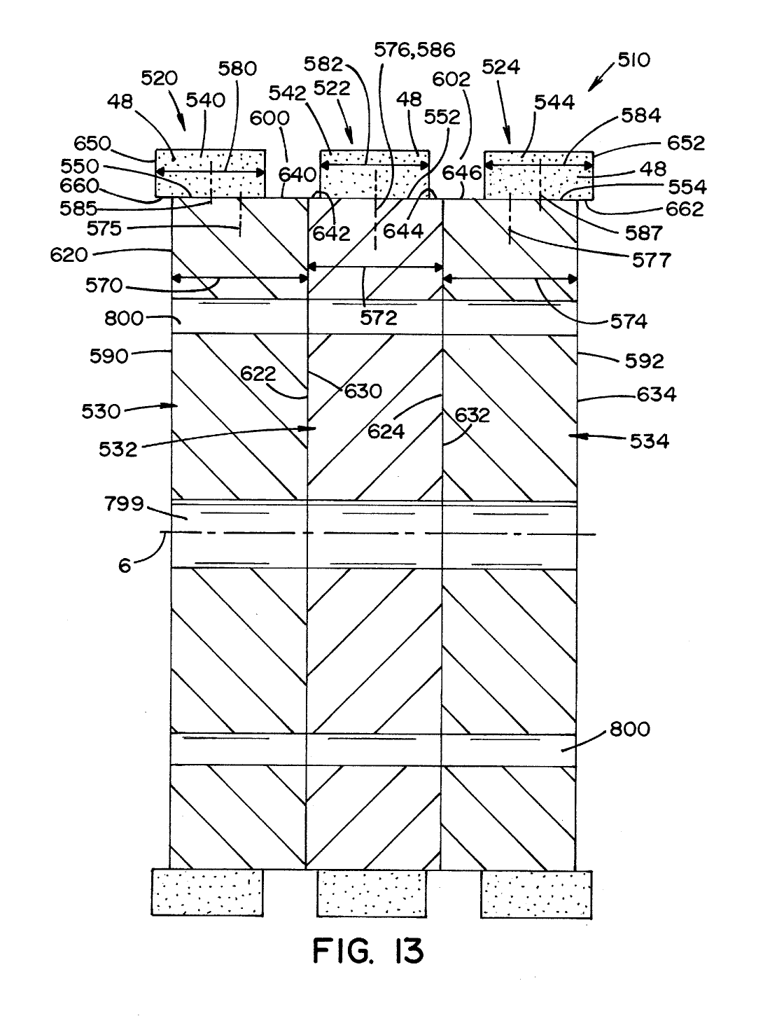

Yet even further, any combination of segments and/or spacings can be utilized in the grinding and/or cutting head and method of this application. In this respect, a blade head according to yet further aspects could include one or more blade blades of one or more of the embodiments of this application and/or one or more prior art blades. One such example is shown in FIG. 12 wherein this figure shows a combination blade head 410 that includes prior art blades A and C described above. In addition, blade head or stack 410 further includes one or more blades 22 described in greater detail above. As is discussed in greater detail above, blade 22 includes core 32 and grinding and/or cutting segment 42. Segment can be any grinding and/or cutting segment and can include diamonds 48. Segment 42 represents a plurality of grinding and/or cutting segments fixed relative to and radially extending from core circumferential edge 52, which is best shown in FIG. 5. Blade core 32 has blade core thickness 72 and segment thickness 82 wherein segment thickness 82 is less than blade core thickness 72 to produce the spacings between the segments. Moreover, blade core 32 has core thickness center 76 and segment 42 has segment thickness center 86. In this embodiment, segment thickness center is aligned with core thickness center wherein the segment is generally centered, which is not required. And, the segment thickness produces segments insets 105 and 106 that are on either side of segment 42. In this set of embodiments, a segment spacing 420 is formed between segments GSA and 42 and a segment spacing 422 is formed between segments 42 and GSC. In addition, spacing 422 can be generally equal to spacing 420, but this is not required. This blade configuration can be used to produce or create a first side clearance or overhang 430 on a first side outside edge 432 and a second side clearance or overhang 440 on a second side outside edge 442 of blade head 410. In the example shown, blade head 410 has a single central blade 22, but the blade head could include multiple central blades 22 (not shown) depending on the dimension of the blades and/or the cut and/or grind being performed. Again, by eliminating spacers, component costs and inventory costs can be reduced. Moreover, labor costs to assemble, repair and/or modify blade head 410 can be reduced in that spacers do not need to be positioned between each blade. Yet even further, blades A and C can be more easily rotated or flipped around to maintain a sharp cutting edge on outside edges 432 and 442.

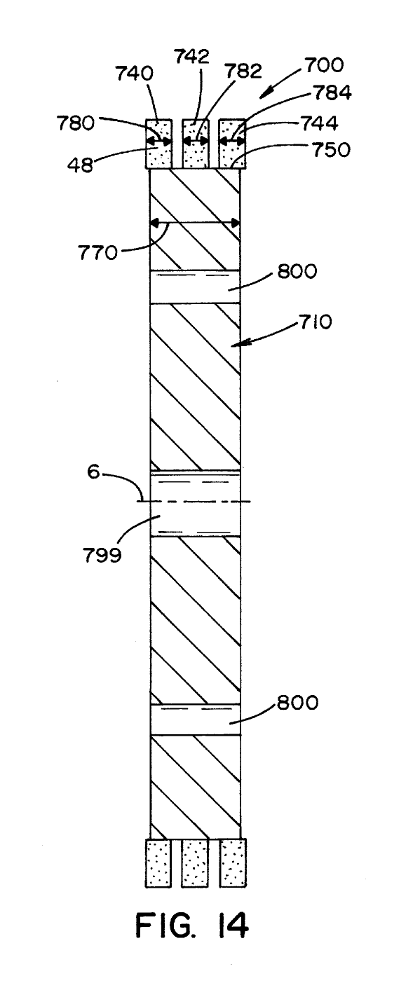

With special reference to FIG. 13, yet another set of embodiments is shown that includes another combination of blades. In this set of embodiments, there are again only three blades shown, which is illustrative only and is not to be limiting. Shown is a blade head 510 and three blades 520, 522 and 524 of blade head 510. Blades 520, 522 and 524 include blade cores 530, 532 and 534, respectively. Further, blades 520, 522 and 524 include grinding and/or cutting segments 540, 542 and 544, respectively. Segments 540, 542 and 544 can include diamonds 48 as are described in greater detail above. Again, as is best shown in FIG. 5, the segments for each blade are a plurality of segments fixed relative to and extending radially from core circumferential edges 550, 552 and 554 of blade cores 530, 532 and 534, respectively. In this embodiment, blade cores 530, 532 and 534 have blade core thicknesses 570, 572 and 574, respectively, and core thickness centers 575, 576 and 577. Similarly, segments 540, 542 and 544 have segment thicknesses 580, 582 and 584, respectively, and segment thickness centers 585, 586 and 587. As with the embodiments above, segment thicknesses 580, 582 and 584 are less than blade core thicknesses 570, 572 and 574, respectively, to produce segments spacings 600 and 602 between the segments without the need for spacers. However, in this set of embodiments, the segment alignment of the segments on the end blades (520 and 524) are opposite to one another and are different than the segment alignment in the one or more central blades 522 of a central region. In this respect, the segment alignment of end blade 520 is shifted left and the segment alignment of blade 524 is shifted right. And, the segment alignment of the one or more central blades 522 is centered. This can be used to create the side clearance for the blade head while still allowing for the spacerless configuration of the blade head.

In this respect, grinding segment 540 is moved axially toward side 590 of blade head 510 of the corresponding blade core and grinding segment 544 is moved axially toward side 592. Segment 542 is centered. Spacing 600 is between segments 540 and 542, and spacing 602 is between segments 542 and 544. Further, the segment shift of the embodiments shown in this figure include segment shift for the outer blades that moves the segments outside beyond the outside edges of the blade cores to produce side clearances on both sides of the head. More particularly, blade cores 530, 532 and 534 have left side core edges (again, in reference to the figures in the drawings) 620, 622 and 624, respectively and right side core edges 630, 632 and 634. Blade 520 has a core inset 640 on the right side of circumferential edge 550; blade 522 has a left core inset 642 and a right core insert 644 on circumferential edge 552. Blade 524 has a core inset 646 on the left side of circumferential edge 554. Further, in that the outer segments are shifted over the outside edges of the edge core, there are also segment overhangs to create side clearances on outside edges 650 and 652 of blade head 510. In greater detail, blade 520 has an overhang 660 on left side 590 and on the base of segment 540. Blade 524 has a right overhang 662 on the right side of the base of segment 544. Blade 522 has no overhang. Thus, spacing 600 between segments 540 and 542 and is a function of core inset 640 and 642. Similarly, spacing 602 between segments 542 and 544 and is a function of core inset 644 and 646. This can produce the same overall segment spacing as discussed above with the same cost savings and performance improvements. However, the spacings can be different between central blades in the blade stack and the outer blades. Further, the segment alignment of this set of embodiments produces side overhangs 660 and 662 on outside edges 650 and 652 for the sides of the blade head.

With special reference to FIG. 14, yet another set of embodiments is shown that includes another combination of blades. In this set of embodiments, shown is a wide body blade that can form the blade stack or be including in the blade stack. In greater detail, the core thickness of one or more blades within the blade stack can be increased to allow space for one or more axially spaced grinding segments or segment sets. And, this arrangement, and ones like it, can be used as a single blade head or can be combined with one or more of the blade arrangement described in this application. Thus, while it will be discussed as a single blade, it can form some or all of a blade head and can be combined within one or more blades or blade arrangements of other embodiments of this application. In the example shown, blade or blade head 700 it is being described in connection with three sets of blade segments, but this is not required wherein more or less than three segment set could be utilized. Blade 700 includes a blade core 710 that includes three sets of grinding and/or cutting segments 740, 742 and 744. Segments 740, 742 and 744 can include diamonds 48 as are described in greater detail above. Again, as is best shown in FIG. 5, the segments for each segment set includes a plurality of segments fixed relative to and extending radially from core circumferential edge 750 of blade core 710. Blade core 710 has blade core thicknesses 770. Segments 740, 742 and 744 have segment thicknesses 780, 782 and 784. In this embodiment, segment thicknesses 780, 782 and 784 are sufficiently less than blade core thicknesses 770 to allow three sets of segments to be positioned about the outer circumferentially edge 750 of core 710. Again, while three sets are shown, more or less could be utilized without detracting from the invention of this application. Moreover, the alignment of the segments can follow any embodiment of this application. As is shown, segments 740 include a left overhang, which is described in greater detail above. Segments 744 include a right overhang, which is described in greater detail above. Segment 742 is generally centered. In the interest of brevity, the descriptions are not being repeated with respect to this embodiment wherein the discussions above are incorporated herein.

As is discussed above, it has also been found that the invention of this application also allows the blades of the blade head to be welded together since there is direct core-to-core contact between adjacent blades. Further, welding the blades of the blade head together can further increase rigidity of the blade head. Moreover, any welding technique could be used to weld the blades together. In one set of embodiments, the blades can include a center bore 799 and one or more weld holes or openings 800 that can be positioned about the blades.

Accordingly, and as is shown, it is to be understood that a wide range of segments and segment positionings relative to the blade core are contemplated for the invention of this application and that these can include combinations of the embodiments of this application and/or prior art blades and blade segments. Thus, the embodiments shown are examples only and are not to be interpreted to limit the invention of this application. Moreover, it has been found a wide range of configuration, even beyond those provided as examples in this application, can realize the advantages found for the invention of this application by providing a blade and/or blade head design that eliminates the blade spacers according to the invention of this application. Moreover, it has been realized that there are multiple advantages over the prior art. As noted above, the blade stacks and/or blades of this application significantly reduce assembly time and cost. Further, the resulting blade stack reduces vibration wherein it results in a more stable blade stack, which improves the performance of the blade stack and extends the service life of the blade stack. Even yet further, the invention of this application prevent debris from getting between the blades in the blade stack, which further reduces vibration and extends blade stack life. Yet even further, the invention of this application allows the blades to be welded together, which further improves the overall stiffness, structure, vibration and service life of the blade stack. Accordingly, the invention of this application has been found to reduce costs while at the same time improve performance and improve longevity.

The invention also include a method of producing a blade head for use in grinding or cutting that eliminates the need for spacers between the blades of the blade head. The blade head including a blade stack with a plurality of circular blades forming the overall blade stack of the blade head. The blade head having a stack plurality configured to rotate together about the head axis and wherein the stack plurality forms the blade stack extending between the first stack extent and the axially opposite second stack extent. The method includes the following steps:
providing a plurality of spacerless blade according to one or more of the embodiments described above;
positioning the spacerless blades relative to one another such that there is core-to-core contact between adjacent blades in the plurality of spacerless blades; and,
securing the plurality of spacerless blades relative to one another to form the blade stack of the blade head and maintain the core-to-core contact.

The method can further include the step of welding the blades to one another.

In that the segment thickness of the grinding segments is less than the blade core thickness both core-to-core contact between adjacent blades is produced along with segments spacings between the adjacent blades without the need for associated blade spacers.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

It is claimed:

1. A blade head for use in grinding or cutting that eliminates spacers between the blades of the blade head, the blade head comprising a stack plurality of circular blades forming an overall blade stack of the blade head, the stack plurality configured to rotate together about a head axis, the stack plurality forming the blade stack extending between a first stack extent and an axially opposite second stack extent, the stack plurality including a plurality of spacerless circular blades, each spacerless blade of the plurality of spacerless circular blades having a spacerless blade core with a first side core surface and a second side core surface that is axially opposite of the first side core surface, the first and second side core surfaces defining a blade core thicknesses, the spacerless blade core having a core thickness center between the first and second side core surfaces, the spacerless blade core further including a circumferential core extent extending about a spacerless blade axis wherein the spacerless blade axis is coaxial with the head axis, said each spacerless blade further including a plurality of grinding or cutting segments circumferentially spaced radially outwardly of the circumferential extent, the plurality of segments each having a first side segment surface and a second side segment surface that is axially opposite of the first side segment surface and including a coating of diamond particles, the first and second side segment surfaces defining a segment thicknesses, said each segment further including a segment thickness center between the first and second side segment surfaces, the segment thickness of the plurality of segments being less than the blade core thickness to allow core-to-core contact between adjacent blades in the plurality of spacerless circular blades while also producing segments spacings in the plurality of segments between the segments of adjacent blades without the need for associated blade spacers.

2. The blade head of claim 1 wherein the segment thickness center is generally aligned with core thickness center.

3. The blade head of claim 1 wherein the plurality of spacerless circular blades is a first plurality of spacerless circular blades and the blade head further includes a second plurality of spacerless circular blades, the first plurality of spacerless circular blades including at least one blade having the segment thickness center being generally aligned with core thickness center and the second plurality of spacerless circular blades including at least one blade having the segment thickness center being generally misaligned with core thickness center.

4. The blade head of claim 3 wherein the stack plurality forming the blade stack includes a first end blade forming the first stack extent and a second end blade forming the second stack extent with central blades between the first and second end blades, the central blades including the first plurality of spacerless circular blades and the first and second end blades including the second plurality of spacerless circular blades.

5. The blade head of claim 1 wherein the stack plurality further includes at least one standard circular blade, the at least one standard blade having a standard blade core with a standard blade core thicknesses and a plurality of grinding or cutting segments circumferentially spaced about a circumferential extent of the standard blade core, the plurality of segments each having a segment thicknesses, the segment thickness of the at least one standard circular blade being greater than the standard blade core thickness.

6. The blade head of claim 5 wherein the stack plurality includes a spacerless blade on either side of the at least one standard circular blade.

7. The blade head of claim 5 wherein the stack plurality forming the blade stack includes a first end blade forming the first stack extent and a second end blade forming the second stack extent with central blades between the first and second end blades, the central blades including the plurality of spacerless circular blades and the first and second end blades including the at least one standard circular blade.

8. The blade head of claim 1 wherein the plurality of spacerless circular blades includes at least one overhand spacerless blade, in the at least one overhang spacerless blade the plurality of segments includes segments having both a segment overhang and a segment inset.

9. The blade head of claim 8 wherein the plurality of spacerless circular blades is a first plurality of spacerless circular blades and the blade head further includes a second plurality of spacerless circular blades, the first plurality of spacerless circular blades including at least one blade having the segment thickness center being generally aligned with core thickness center and the second plurality of spacerless circular blades including the at least one overhang spacerless blade.

10. The blade head of claim 9 wherein the stack plurality forming the blade stack includes a first end blade forming the first stack extent and a second end blade forming the second stack extent with central blades between the first and second end blades, the central blades including the first plurality of spacerless circular blades, the first and second end blades being overhand spacerless blade.

11. The blade head of claim 1 wherein the stack plurality forming the blade stack includes a first end blade forming the first stack extent and a second end blade forming the second stack extent with central blades between the first and second end blades, the central blades including the plurality of spacerless circular blades.

12. The blade head of claim 1 wherein the circumferential core extent extending about the spacerless blade axis of said each spacerless blade is formed by a circumferential core surface, the plurality of segments being fixed relative to circumferential core surface.

13. The blade head of claim 1 wherein the plurality of spacerless circular blades includes at least one wide body blade wherein the circumferential core extent extending about the wide body blade is formed by a circumferential core surface, the plurality of segments being fixed relative to circumferential core surface, the plurality of segments includes a first plurality of segments and a second plurality of segments wherein the first plurality of segments is axially spaced from the second plurality of segments.

14. The blade head of claim 13 further including a third plurality of segments between the first and second plurality of segments.

15. The blade head of claim 1 wherein the plurality of spacerless circular blades are welded together at one or more weld joints.

16. The blade head of claim 15 wherein the core of said each spacerless blade of the plurality of spacerless circular blades includes a plurality of welding openings, the one or more weld joints including weld joints in the plurality of weld openings.

17. The blade head of claim 1 wherein the first side surface and the second side surface covers substantially all of the sides of the core.

18. The blade head of claim 1 wherein the plurality of spacerless circular blades are substantially the same.

19. The blade head of claim 1 wherein the circumferential extent is a circular edge and the plurality of segments are fixed relative to the circular edge.

20. The blade head of claim 1 wherein the first side core surface and the first side segment surface are parallel and the second side core surface and the second side segment surface are parallel.
